(19) United States
(12) Patent Application Publication
(10) Pub. No.: US 2017/0278293 A1
(43) Pub. Date: Sep. 28, 2017

(54) Processing a Texture Atlas Using Manifold Neighbors

(71) Applicant: Google Inc., Mountain View, CA (US)

(72) Inventor: Stephen Charles Hsu, San Carlos, CA (US)

(21) Appl. No.: 13/945,390

(22) Filed: Jul. 18, 2013

(51) Int. Cl. G06T 15/04

(52) U.S. Cl. CPC G06T 15/04

(57) ABSTRACT

Systems and methods for processing textures to be applied to surface of a three-dimensional model, such as a three-dimensional model of a geographic area, are provided. According to aspects of the present disclosure, a two-dimensional image processing operation can be performed in the two-dimensional texture atlas space defined by a texture atlas using manifold neighborhoods defined for pixels in the texture atlas. The manifold neighborhood for a pixel can be the set of texture atlas pixels whose corresponding position on the surface of the three-dimensional model lies within a threshold distance of the surface position corresponding to the pixel in the three-dimensional model. The two-dimensional image processing operations can be performed using the set of texture atlas pixels in the manifold neighborhood.

### FIELD

The present disclosure relates generally to computer graphics and more particularly to systems and methods for processing textures that are mapped to three-dimensional models.

### BACKGROUND

Computer graphics applications can be used to render a three-dimensional model. For instance, an interactive geographic information system can render an interactive three-dimensional model of a geographic area in a suitable user interface, such as a browser. A user can navigate the three-dimensional model by controlling a virtual camera that specifies what portion of the three-dimensional model is rendered and presented to a user. The three-dimensional model can include a polygon mesh, such as a triangle mesh, used to model the geometry (e.g. terrain, buildings, and other objects) of the geographic area.

Textures, such as satellite images or aerial imagery, can be applied to the surface of the three-dimensional model to give the three-dimensional model of the geographic area a more realistic appearance. The textures can be represented in a two-dimensional image known as a texture atlas. A texture function can map a correspondence from points in the texture atlas to points on the surface of the three-dimensional model. It is common to partition the surface of the three-dimensional model into parts and to define a separate continuous correspondence for each part of the three-dimensional model to a sub-region in the texture atlas, called a chart. Portions of the texture atlas that are not mapped to any portion of the three-dimensional model are invalid points.

When the textures for the three-dimensional model are composited from a plurality of different source images, any illumination and exposure differences among the source images can lead to unnatural color discontinuities in the textured three-dimensional model at the boundaries of the source images. Textures can be processed using two-dimensional image processing techniques to reduce discontinuities. For instance, blending techniques, such as multi-band blending, or other image processing techniques can be performed to correct for discontinuities in the imagery provided in the geographic information system. These techniques typically combine spatially nearby pixels of an input image to derive pixels of an output image. Directly applying two-dimensional image processing techniques in the texture atlas space may not yield desired results because a fixed sized neighborhood of pixels in the texture atlas space can correspond to variable sized and possibly disconnected sets of three-dimensional points on the surface of the three-dimensional model and can even include invalid points.

Two-dimensional image processing techniques have been adapted to three-dimensional models in various ways. For instance, the three-dimensional model can be partitioned into overlapping parts, each with its own chart in a texture atlas. Each chart in the texture atlas can then be processed independently. Alternatively, the textures mapped to the surface of the three-dimensional model can be mapped to a single two-dimensional image (e.g. by orthographic projection). The two-dimensional image can be processed and then back-projected to the three-dimensional model. These techniques do not always respect the local spatial structure of points on the surface of the three-dimensional model.

### SUMMARY

Aspects and advantages of the invention will be set forth in part in the following description, or may be obvious from the description, or may be learned through practice of the invention.

One exemplary aspect of the present disclosure is directed to a method of performing a two-dimensional image processing operation on a texture atlas mapped to a surface of a three-dimensional model. The method includes accessing, with a computing device, the texture atlas. The texture atlas includes a first pixel mapped to a first point on a surface of the three-dimensional model. The method further includes defining, with the computing device, a manifold neighborhood for the first pixel. The manifold neighborhood includes a set of second pixels. Each second pixel in the set of second pixels respectively corresponds to a second point on the surface of the three-dimensional model located within a threshold distance of the first point on the surface of the three-dimensional model. The method further includes performing, with the computing device, a two-dimensional image processing operation on the texture atlas based at least in part on the manifold neighborhood defined for the first pixel.

Other exemplary implementations of the present disclosure are directed to systems, apparatus, non-transitory computer-readable media, and devices for performing a two-dimensional processing operation on textures mapped to a surface of a three-dimensional model.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary texture atlas mapped to a three-dimensional model according to an exemplary embodiment of the present disclosure;

FIG. 2 depicts an exemplary three-dimensional model defining a three-dimensional space according to an exemplary embodiment of the present disclosure;

FIG. 3 depicts an exemplary texture atlas and manifold neighborhood according to an exemplary embodiment of the present disclosure;

FIG. 4 depicts a flow diagram of an exemplary method for processing a texture atlas according to an exemplary embodiment of the present disclosure;

FIG. 5 depicts a flow diagram of an exemplary method for identifying a manifold neighborhood for a pixel in a texture atlas according to an exemplary embodiment of the present disclosure;

FIG. 6 depicts an exemplary downsampling operation according to an exemplary embodiment of the present disclosure;

FIG. 7 depicts an exemplary upsampling operation according to an exemplary embodiment of the present disclosure; and

FIG. 8 depicts an exemplary computing environment according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

### Overview

Generally, the present disclosure is directed to a system and method for processing textures to be applied to surface of a three-dimensional model, such as a three-dimensional model of a geographic area. For instance, in the context of a geographic information system, textures applied to a three-dimensional model from a plurality of source images can be processed using a multi-band blending operation to remove discontinuities, providing a more realistic three-dimensional representation of a geographic area of interest. The two-dimensional image processing operation typically derives pixel values (e.g. color values) for output pixels in a processed image based on locally adjacent pixel values.

According to aspects of the present disclosure, the textures can be processed in a two-dimensional texture atlas space defined by a texture atlas. A texture atlas is a two-dimensional image that includes textures for mapping to different portions of a surface of the three-dimensional model. Pixels of the texture atlas are mapped to the surface of the three-dimensional model according to a texture function. The spatial relationship between pixels in a texture atlas does not always directly correspond to the spatial relationship among the pixels when mapped to the three-dimensional model.

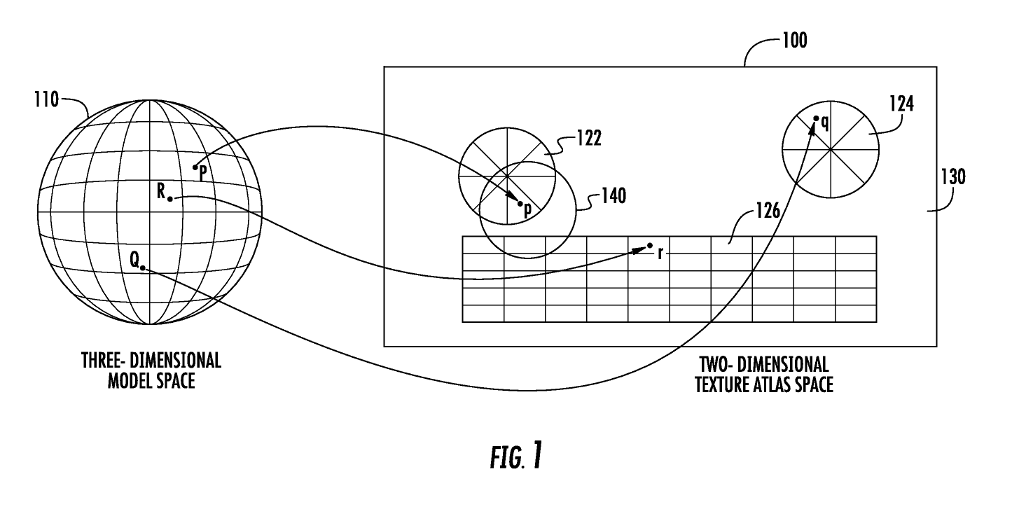

For example, FIG. 1 depicts an exemplary texture atlas 100 mapped to a three-dimensional model 110. As shown, the texture atlas 100 is a two-dimensional image defining a two-dimensional texture atlas space. Certain of the pixels of the texture atlas 100 are mapped to a point on a surface of the three-dimensional model 110 according to a texture function. The texture function specifies corresponding locations on the surface of the three-dimensional model 110 where pixels in the texture atlas 100 are to be projected. In the example of FIG. 1, the pixel p is mapped to point P in the three-dimensional model 110. The pixel q is mapped to point Q in the three-dimensional model 110. The pixel r can be mapped to point R in the three-dimensional model 110. The texture atlas 100 also includes invalid points 130 that are not mapped to any portion of the three-dimensional model 110. The invalid points 130 typically are associated with uniform pixel values attributable to a predefined color (e.g. black).

The texture atlas 100 includes a plurality of charts, namely charts 122, 124, and 126. Each chart 122, 124, and 126 can map a different continuous texture to a different portion of the three-dimensional model. Three charts 122, 124, and 126 are depicted in FIG. 1 for purposes of illustration and discussion. Those of ordinary skill in the art, using the disclosures provided herein, will understand that the texture atlas 100 can include any number of charts without deviating from the scope of the present disclosure.

Performing a two-dimensional image processing operation in the texture atlas space defined by the texture atlas 100 can result in the combining of pixels that are not located spatially near to one another in the three-dimensional space defined by the three-dimensional model 110. For instance, a two-dimensional image processing operation performed in the texture atlas space can determine a pixel value for pixel p in an output texture atlas based on pixels within zone 140 locally adjacent to the pixel p in the texture atlas 100. As shown, the zone 140 includes pixels that are in chart 126 that may not be mapped to a location adjacent the pixel p in the three-dimensional model. The zone 140 can also invalid pixels 130. The two-dimensional processing operation, therefore, takes into account invalid pixels 130 and pixels that are not spatially near the pixel in the three-dimensional space defined by the three-dimensional model 110, resulting in a reduced quality of the processed texture.

According to aspects of the present disclosure, the two-dimensional image processing operation can be performed in the two-dimensional texture atlas space defined by a texture atlas using manifold neighborhoods defined for pixels in the texture atlas. More particularly, a manifold neighborhood can be defined for one or more pixels in the texture atlas. The manifold neighborhood for a pixel can be the set of texture atlas pixels whose corresponding position on the surface of the three-dimensional model lies within a threshold distance of the surface position corresponding to the pixel in the three-dimensional model. The manifold neighborhood can include pixels that are non-local in the texture atlas space. For instance, the pixels in the manifold neighborhood can cross between separate charts in the texture atlas. Since invalid points do not correspond to any point on the surface of the three-dimensional model, the invalid pixels in the texture atlas are automatically excluded from the manifold neighborhood.

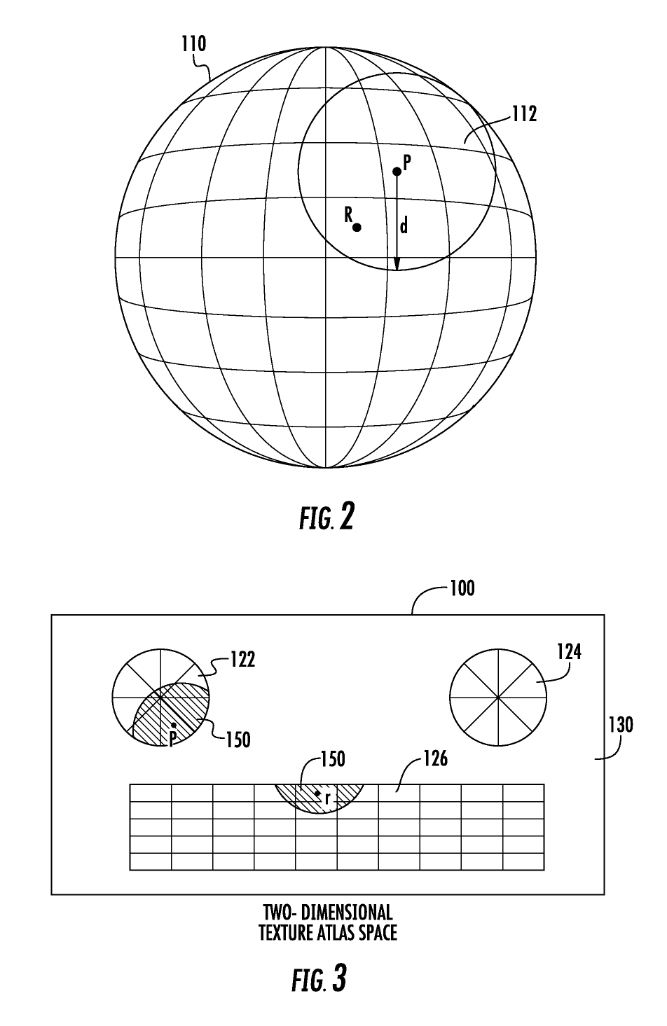

In one implementation, the manifold neighborhood for a pixel can be identified by identifying the point on the surface of the three-dimensional model corresponding to the pixel. A set of points within a threshold distance of the point on the three-dimensional model can then be identified. For example, FIG. 2 depicts an enlarged view of the three-dimensional model 110 of FIG. 1. The point P on the three-dimensional model 110 can be identified as corresponding to pixel p in the texture atlas 100 of FIG. 1. As shown in FIG. 2 a set of points 112 are located within a threshold distance d of the point P.

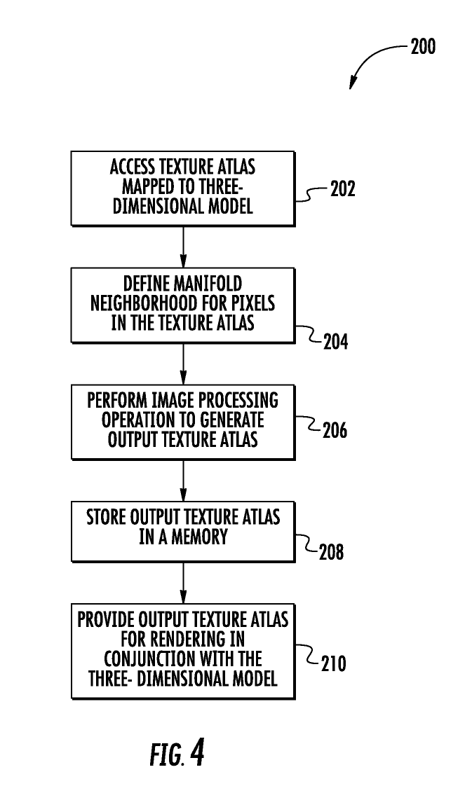

Once the set of points within threshold distance have been identified, the set of pixels in the texture atlas corresponding to the set of points can be identified, for instance, from the texture function. The set of pixels in the texture atlas corresponding to the set of points can be defined as the manifold neighborhood for the pixel. For instance, FIG. 3 depicts an enlarged view of the texture atlas 100 of FIG. 1. The shaded pixels are the set of pixels that correspond to the set of points 112 in the three-dimensional model 110 of FIG. 2. The shaded pixels can be defined as the manifold neighborhood 150 for the pixel p. Notice that the manifold neighborhood 150 of FIG. 3 extends across charts 122 and 126 and does not include any invalid pixels.

Once the manifold neighborhoods for pixels in the texture atlas are defined, a two-dimensional image processing operation can be used to produce an output texture atlas. The pixel values for respective pixels in the output texture atlas can be determined using the set of pixels in its corresponding manifold neighborhood. Multiple different image processing techniques can be performed in the texture atlas space using the manifold neighborhoods of the respective pixels. For instance, multi-band blending operations, compression operations, enhancement operations, editing operations, synthesis operations, fusion operations, and other operations can be performed in the texture atlas space. Using the manifold neighborhoods allows for the two-dimensional image processing operation to be performed in the texture atlas space in a manner that respects the spatial proximity of the pixels in the three-dimensional space defined by the three-dimensional model.

For instance, the manifold neighborhood 150 for pixel p shown in FIG. 3 extends across charts 122 and 126 and includes pixel r. Pixel r is not spatially nearby the pixel p in the texture atlas 100. However, the point R on the surface of the three-dimensional model 110 of FIG. 2 corresponding to the pixel r is spatially nearby the point P on the surface of the three-dimensional model 110 corresponding to the pixel p. As a result, the pixel r is included in the manifold neighborhood 150 for pixel p. When performing a two-dimensional image processing operation using the manifold neighborhood 150, the pixel r is used to determine a pixel value for an output pixel corresponding to the pixel p. In this regard, the two-dimensional image processing operation can be performed in the two-dimensional texture atlas space in a manner that takes into account the proximity of the pixels in the three-dimensional space defined by the three-dimensional model 110.

In one particular implementation, the manifold neighborhood can be used to generate an image pyramid associated with the texture atlas. The image pyramid can include a plurality of levels of progressively lower resolution. The differing levels of the image pyramid can be performed by downsampling or upsampling the various levels in the image pyramid. The downsampling or upsampling operations can be performed using the manifold neighborhoods defined for each pixel. For instance, in one exemplary downsampling operation, each pixel in a coarser level of the image pyramid can be determined based on the pixel values of the pixel's manifold neighborhood in the finer level. In an exemplary upsampling operation, each pixel in a finer level of the image pyramid can be determined based on the pixel values of the pixel's manifold neighborhood in the coarser level.

The upsampling and downsampling operations can be used to implement a multi-band filtering operation. In particular, a Gaussian pyramid can be constructed from the texture atlas, a Laplacian pyramid can be generated from the Gaussian pyramid, and a reconstructed Gaussian pyramid can be generated from the Laplacian pyramid. In this manner, multi-band blending can be performed in the texture atlas space to achieve blending over the surface of the three-dimensional model, even between different charts of the texture atlas.

### Exemplary Method of Processing Textures in a Texture Atlas Space

FIG. 4 depicts a flow diagram of an exemplary method (200) for processing textures in a texture atlas space according to an exemplary embodiment of the present disclosure. The method (200) can be implemented by any suitable computing device, such as any of the computing devices in the computing system 600 depicted in FIG. 8. In addition, FIG. 4 depicts steps performed in a particular order for purposes of illustration and discussion. Those of ordinary skill in the art, using the disclosures provided herein, will understand that the various steps of any of the methods disclosed herein can be omitted, expanded, adapted, rearranged, and/or modified in various ways.

At (202), the method includes accessing a texture atlas mapped to a three-dimensional model. The three-dimensional model can include a polygon mesh having a plurality of mesh polygons (e.g. triangles) interconnected by vertices and edges. Each mesh polygon includes a polygon face that represents a portion of a surface of the three-dimensional model. The texture atlas can be a two-dimensional image having a plurality of pixels. Each pixel can have a pixel value specifying color and/or other attributes (e.g. transparency) attributable the pixel. Portions of the texture atlas can be mapped to the surface of the polygon mesh according to a texture function to apply color to the surface of the polygon mesh. Accessing the texture atlas can include accessing a texture atlas stored, for instance, in a memory, or can include generating the texture atlas for mapping to the three-dimensional model from source imagery.

In the example where the three-dimensional model is a three-dimensional model of a geographic area, the polygon mesh can be a stereo reconstruction generated from aerial or satellite imagery of the geographic area. The imagery can be taken by overhead cameras, such as from aircraft, at various oblique or nadir perspectives. In the imagery, features can be detected and correlated with one another. The points can be used to determine a stereo mesh from the imagery using stereo matching techniques. In this way, a three-dimensional polygon mesh can be determined from two-dimensional imagery

The texture atlas can map textures generated from source imagery of the geographic area to the polygon mesh. The source imagery can be geographic imagery of the geographic area captured, for instance, by a camera from an overhead perspective, such as satellite imagery or aerial imagery of the geographic area. The texture atlas can be generated using a texture selection algorithm that selects source images for mapping to each portion of the surface of the polygon mesh based on various parameters, such as view angle associated with the source imagery. The textures represented in the texture atlas can be applied to the surface of the polygon mesh during rendering to provide a more realistic graphical representation of the three-dimensional model of the geographic area.

At (204), a manifold neighborhood can be defined for one or more pixels in the texture atlas. The manifold neighborhood for a pixel can be a set of pixels that are spatially nearby in three-dimensional space to the corresponding location of the pixel on the surface of the three-dimensional model. For instance, the manifold neighborhood for a first pixel mapped to a first point on a surface of a three-dimensional model can be a set of second pixels respectively corresponding to second points on the surface of the three-dimensional model located within a threshold distance of the first point on the surface of the three-dimensional model.

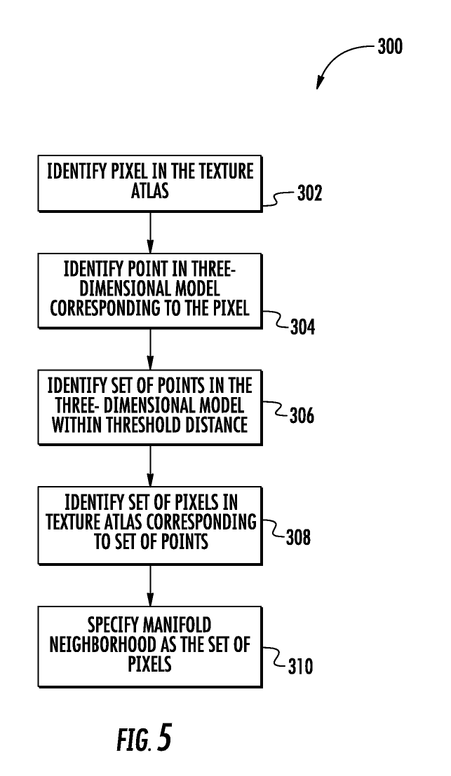

FIG. 5 depicts an exemplary method (300) for defining a manifold neighborhood for a pixel according to an exemplary embodiment of the present disclosure. At (302), the method includes identifying a pixel in the texture atlas. For instance, referring to FIG. 3, a pixel p can be identified in the texture atlas 100. At (304) of FIG. 5, a point on the surface corresponding to the pixel can be identified. For instance, the point P on the surface of the three-dimensional model 110 of FIG. 2 can be identified as corresponding to the pixel p in the texture atlas 100 of FIG. 3. The point on the surface of the three-dimensional model corresponding to the pixel can be identified from the texture function mapping the texture atlas to the three-dimensional model.

At (306), the method can identify a set of points on the surface of the three-dimensional model within a threshold distance of the point corresponding to the pixel in the texture atlas. For example, the set of points 112 within a threshold distance d of the point P in the three-dimensional model 110 of FIG. 2 can be identified. The threshold distance can be defined in various ways. For instance, the threshold distance can be a Euclidean distance or a geodesic distance.

At (308), the set of pixels in the texture atlas corresponding to the set of points 112 are identified. The set of pixels corresponding to the set of points can be identified using the texture function mapping the texture atlas to the three-dimensional model. Referring to the example of FIG. 3, the shaded pixels can be identified as corresponding to the set of points 112 on the surface of the three-dimensional model 110.

At (310), the manifold neighborhood is specified as the identified set of pixels. For instance, the manifold neighborhood 150 for pixel p in FIG. 3 is specified as the set of shaded pixels corresponding to the set of points 112 on the three-dimensional model 110 of FIG. 2. The method (300) can be repeated to identify manifold neighborhoods for additional pixels in the texture atlas. For instance, the method (300) can be performed for each pixel in the texture atlas that is mapped to a point on the surface of a three-dimensional model.

Referring back to FIG. 4 at (206), a two-dimensional image processing operation is performed on the texture atlas to generate an output texture atlas based on the manifold neighborhoods defined for pixels in the texture atlas. The two-dimensional image processing operation can combine pixel values associated with pixels in a manifold neighborhood to determine the pixel value of an output pixel in the output texture atlas. The two-dimensional image processing operation can be a multi-band blending operation, compression operation, enhancement operation, editing operation, synthesis operation, fusion operation, or other suitable operation.

More particularly, the two-dimensional operation can be performed by constructing an output texture atlas having a plurality of output pixels. Each of the plurality of output pixels corresponds to a pixel in the original texture atlas and is mapped to the surface of the three-dimensional model according to a texture function in a similar manner. The output pixels of the output texture atlas can have different pixel values relative to the original texture atlas as a result of the two-dimensional image processing operation.

According to particular aspects of the present disclosure, a pixel value for an output pixel in the output texture atlas is determined based at least in part on the manifold neighborhood associated with the output pixel. For instance, a first pixel in the texture atlas can have a manifold neighborhood that includes a set of second pixels. The pixel value for the output pixel corresponding to the first pixel can be determined based on the pixel values associated with the second pixels. Referring to the example of FIG. 3, the pixel value for an output pixel corresponding to pixel p can be determined based on the pixel values of the pixels in the manifold neighborhood 150. The pixel value can be set to the output pixel in the output texture atlas after the pixel value has been determined.

Referring back to FIG. 4 at (208), the output texture atlas can be stored in a memory. For instance, the output texture atlas can be ingested along with a polygon mesh and stored in a database for later access. In one implementation, the output texture atlas can be stored in a hierarchical tree data structure, such as a quadtree data structure or an octree data structure, that spatially partitions the data according to geographic coordinates of its elements.

At (210), the output texture atlas can be provided or served for rendering a graphical representation of the three-dimensional model. For instance, the output texture atlas can be served to a remote client device along with other geographic data. A graphical representation of the three-dimensional model can be rendered on the display of the remote computing device. A user can interact with the three-dimensional model, for instance, to view the three-dimensional model from different perspectives, using a suitable user interface. The user interface can provide tools to allow the user to zoom, pan, tilt, or otherwise navigate a virtual camera to view the three-dimensional model from differing perspectives.

### Exemplary Application to Generation of Image Pyramids for Multi-Band Blending

One exemplary two-dimensional image processing operation that can be performed in the texture atlas space according to an exemplary embodiment of the present disclosure is a multi-band blending operation. Multi-band blending can involve decomposing the texture atlas into different frequency bands where the different bands have differing levels of resolution. Blending operations can be performed in each band to remove discontinuities in the texture atlas.

A multi-band blending operation can be implemented by constructing image pyramids of the texture atlas. An image pyramid is a multi-scale representation of the texture atlas where successive frequency bands are represented as different levels in the image pyramid. The levels of the pyramid can have progressively lower resolution as the image pyramid progresses from a base level to higher levels in the pyramid. The levels of the pyramid can be generated by upsampling or downsampling other levels in the image pyramid.

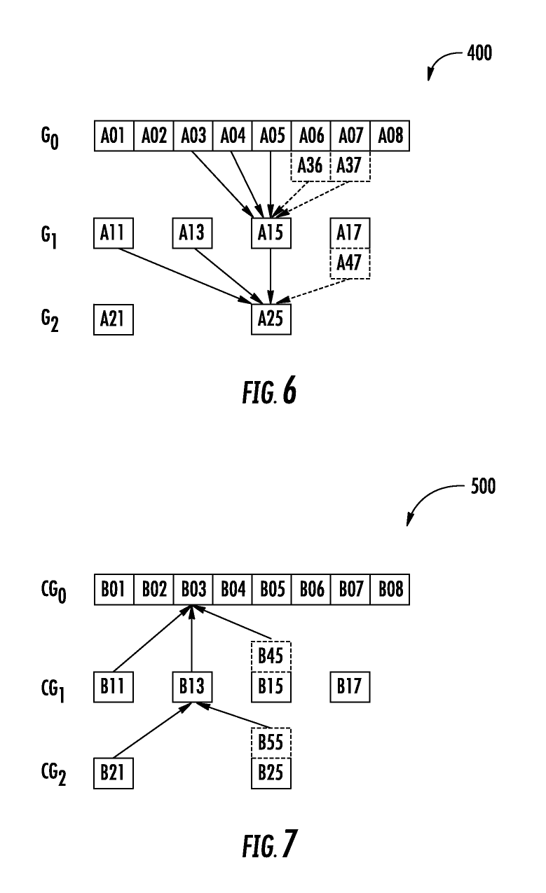

For instance, FIG. 6 depicts an exemplary image pyramid 400 constructed from a texture atlas according to an exemplary embodiment of the present disclosure. The exemplary image pyramid 400 can be a Gaussian pyramid of the texture atlas constructed, for instance, during a multi-band blending operation. The exemplary image pyramid 400 is represented as a one-dimensional array of pixels for purposes of illustration and discussion. Those of ordinary skill in the art, using the disclosure provided herein, will understand that the one-dimensional array of pixels can be representative of a two-dimensional array.

As shown, the image pyramid 400 includes a plurality of levels, including a base level G₀, a first level G₁, and a second level G₂. More layers can be included in the image pyramid 400 without deviating from the scope of the present disclosure The base level G₀ can be associated with the texture atlas. As shown, the base level G₀ includes a plurality of pixels A01, A02, A03, A04, A05, A06, A07, and A08 that are locally adjacent to one another in the texture atlas. The base level G₀ can further include other pixels that are not locally adjacent, such as pixels A36 and A37. Pixels A36 and A37 can be located, for instance, in a different chart of the texture atlas than pixels A01, A02, A03, A04, A05, A06, A07, and A08.

The first level G₁ of the image pyramid 400 can be generated by downsampling the base level G₀. In particular, base level G₀ can include pixels A01, A02, A03, A04, A05, A06, A07, and A08 designated by row and column indices. The first level G₁ can be constructed as including pixels A11, A13, A15, A17 respectively corresponding to A01, A03, A05, and A07. According to aspects of the present disclosure, the downsampling operation can be accomplished by determining pixel values for the pixels in level G₁ based on pixels in the manifold neighborhoods associated with the pixels in the base level G₀. The pixel values can then be set to the pixels in the level G₁.

For example, the manifold neighborhood in level G₀ for pixel Al5 in the first level G₁ can include pixels A03, A04, A05, A36, and A37. Instead of determining the pixel value for A15 using locally adjacent pixels A03, A04, A05, A06, and A07, the pixel value for A15 can be determined using pixels A03, A04, A05, A36, and A36 in the manifold neighborhood associated with pixel A15. The pixel values for pixels A21 and A25 in the next higher level G₂ of the image pyramid 400 can be determined in a similar manner. For instance, the manifold neighborhood in level G₁ associated with pixel A25 in the second level G₂ can include pixels A11, A13, A15, and A47 in the first level G₁ of the image pyramid 400. Instead of determining the pixel value for A25 using locally adjacent pixels A11, A13, A15, and A17, the pixel value for A25 can be determined using pixels A11, A13, A15, and A47 in the manifold neighborhood associated with pixel A25.

In one particular implementation, the downsampling operation can determine pixel values for pixel in the next higher level using a weighted average of the pixels in the manifold neighborhood. A weighting factor can be determined for each pixel in the manifold neighborhood based on the distance (measured in pixels) in three-dimensional space between the point corresponding to the pixel in the manifold neighborhood and the point corresponding to the pixel in the next higher level. For instance, the weighting factor can be assigned using a Gaussian function as follows:

$$w = {e}^{\frac{- {d}^{2}}{2 {σ}^{2}}}$$

where w is the weighting factor for the pixel in the manifold neighborhood, d is the distance in three-dimensional space (measured in pixels) between the pixel in the manifold neighborhood and the point corresponding to the pixel in the next higher level, and a is the standard deviation that is proportional to the radius in pixels of the manifold neighborhood (e.g. half the radius).

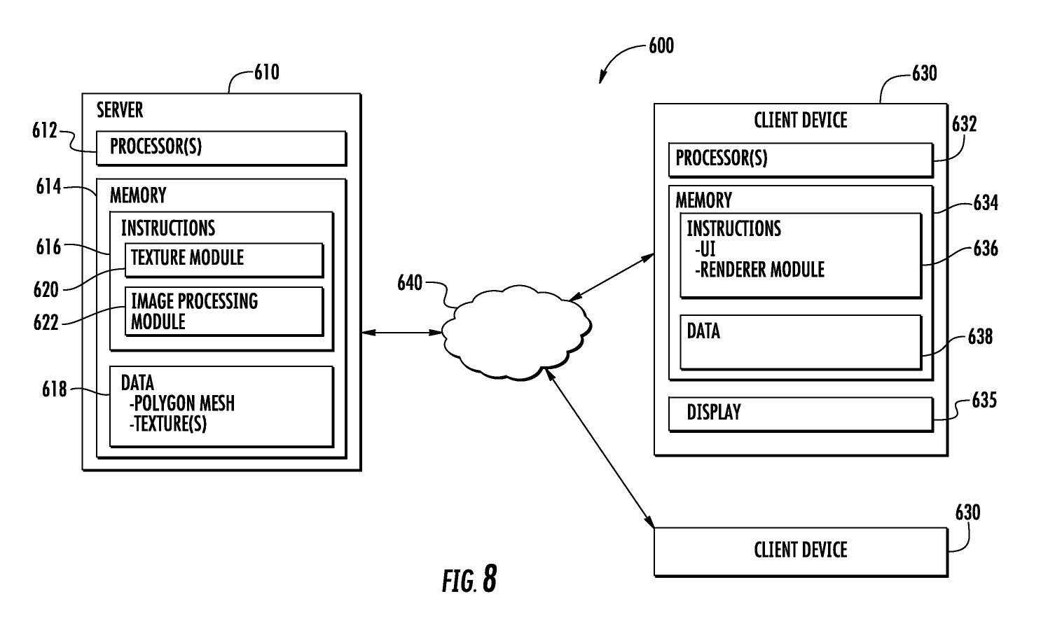

Upsampling operations can be performed using manifold neighborhoods in a manner similar to downsampling operations. For instance, FIG. 7 depicts an exemplary image pyramid 500 constructed from a texture atlas according to an exemplary embodiment of the present disclosure. The exemplary image pyramid 500 can be a reconstructed Gaussian pyramid of the texture atlas constructed, for instance, during a multi-band blending operation. The exemplary image pyramid 500 is represented as a one-dimensional array of pixels for purposes of illustration and discussion. Those of ordinary skill in the art, using the disclosure provided herein, will understand that the one-dimensional array of pixels can be representative of a two-dimensional array.

As shown, the image pyramid 500 includes a plurality of levels, including a base level CG₀, a first level CG₁, and a second level CG₂. More layers can be included in the image pyramid 500 without deviating from the scope of the present disclosure. The base level CG₀ can be associated with an output texture atlas generated by the multi-band blending operation. As shown, the base level CG₀ includes a plurality of pixels B01, B02, B03, B04, B05, B06, B07, and B08 that are locally adjacent to one another in the output texture atlas.

The second level CG₂ can include pixels B21 and B25 that are locally adjacent to one another. The second level can further include pixel B55. Pixel B55 can be associated with a different chart in the texture atlas than pixels B21 and B25. The first level CG₁ of the image pyramid 500 can be generated by upsampling the second level CG₂. The first level CG₁ can be constructed as including pixels B11, B13, B15, and B17 that are locally adjacent. The first level CG₁ can also include pixel B45. Pixel B45 can be associated with a different chart in the texture atlas than pixels B11, B13, B15, and B17.

The levels of the image pyramid 500 can be generated by upsampling the higher levels in the pyramid. For instance, the upsampling operation can be accomplished by determining pixel values for the pixels in level CG₁ based on pixels in the manifold neighborhood of the corresponding pixels in the next higher level CG₂. The pixel values can then be set to the pixels in the level CG₁. For example, the manifold neighborhood in level CG₂ for pixel B13 can include pixels B21 and B55. Instead of determining the pixel value for B13 using locally adjacent pixels B21 and B25, the pixel value for B13 can be determined using pixels B21 and B55 in the manifold neighborhood associated with pixel B13.

The pixel values for pixels in the base level G₀ of the image pyramid 500 can be determined in a similar manner. For instance, the manifold neighborhood for B03 can include pixels B11, B13, and B45. Instead of determining the pixel value for B03 using locally adjacent pixels B11, B13, and B15, the pixel value for B03 can be determined using pixels B11, B13, and B45 in the manifold neighborhood associated with pixel B03.

Similar to the downsampling operation, the upsampling operation can determine pixel values for pixels in the next lower level using a weighted average of the pixels in the manifold neighborhood. A weighting factor can be determined for each pixel in the in the manifold neighborhood based on the distance (measured in pixels) in three-dimensional space between the point corresponding to the pixel in the manifold neighborhood and the point corresponding to the pixel in the next lower level. For instance, the weighting factor can be assigned using a Gaussian function as follows:

$$w = {e}^{\frac{- {d}^{2}}{2 {σ}^{2}}}$$

where w is the weighting factor for the pixel in the manifold neighborhood, d is the distance in three-dimensional space (measured in pixels) between the pixel in the manifold neighborhood and the point in the next lower level, and σ is the standard deviation that is proportional to the radius in pixels of the manifold neighborhood (e.g. half the radius).

The downsampling and upsampling operations discussed above can be used to implement a multi-band blending operation. For instance, a downsampling operation can be performed to generate a Gaussian pyramid from the texture atlas. A Laplacian Pyramid can be determined from the Gaussian pyramid. For instance, each level of the Laplacian pyramid can be constructed by subtracting the upsampling of the next coarser level of the Gaussian pyramid from the corresponding level of the Gaussian pyramid, A reconstructed Gaussian pyramid can then be reconstructed using an upsampling operation. For instance, each level of the reconstructed Gaussian pyramid can be computed by adding the same level of the Laplacian pyramid and the upsampling of the next coarser level of the reconstructed Gaussian pyramid. In a particular implementation, scene dependent filtering can be implemented in conjunction with the multi-band blending operation. The scene dependent filtering can avoid the blending of pixels corresponding to different structures or objects depicted in the texture atlas.

In one exemplary embodiment of the present disclosure, the above downsampling and upsampling operations can be approximated by exploiting regularity among the set of manifold neighborhoods defined for pixels in the texture atlas. When designing correspondence between points on the surface of the three-dimensional model to the texture atlas, it is common to avoid excessive geometric distortion within each chart. As a result, it can be beneficial to consider the average resolution of pixels for each chart and on that basis to approximate a fixed size manifold neighborhood on the surface of the three-dimensional model corresponding to a fixed size approximated manifold neighborhood in the texture atlas. The fixed size approximated manifold neighborhood can be used to approximate pixel values for all pixels that are not close to a boundary in the chart. For example, a five-by-five array of pixels with weights determined on a Gaussian distribution can be used to perform upsampling or downsampling operations. The pixel values for a pixel near a chart boundary can use the true manifold neighborhood associated with the pixel. Because most pixels in a texture atlas will typically not be located near a chart boundary, the costs of computing and storing true manifold neighborhood can be significantly reduced by using approximated manifold neighborhoods.

### Exemplary Computing Environment for Processing Textures

FIG. 8 depicts an exemplary computing system 600 that can be used to implement the methods and systems for processing and rendering textures according to aspects of the present disclosure. The system 600 is implemented using a client-server architecture that includes a server 610 that communicates with one or more client devices 630 over a network 640. The system 600 can be implemented using other suitable architectures, such as a single computing device.

The system 600 includes a server 610, such as a web server used to host a geographic information system. The server 610 can be implemented using any suitable computing device(s). The server 610 can have a processor(s) 612 and a memory 614. The server 610 can also include a network interface used to communicate with one or more client devices 630 over a network 640. The network interface can include any suitable components for interfacing with one more networks, including for example, transmitters, receivers, ports, controllers, antennas, or other suitable components.

The processor(s) 612 can be any suitable processing device, such as a microprocessor, microcontroller, integrated circuit, or other suitable processing device. The memory 614 can include any suitable computer-readable medium or media, including, but not limited to, non-transitory computer-readable media, RAM, ROM, hard drives, flash drives, or other memory devices. The memory 614 can store information accessible by processor(s) 612, including instructions 616 that can be executed by processor(s) 612. The instructions 616 can be any set of instructions that when executed by the processor(s) 612, cause the processor(s) 612 to provide desired functionality. For instance, the instructions 616 can be executed by the processor(s) 612 to implement a texture module 620, an image processing module 622, and other modules.

The texture module 620 can be configured to access a texture atlas and to define a manifold neighborhood for one or more pixels in the texture atlas according to exemplary aspects of the present disclosure. The image processing module 622 can be configured to perform a two-dimensional image processing operation on the texture atlas using the manifold neighborhoods according to exemplary aspects of the present disclosure.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media.

Memory 614 can also include data 618 that can be retrieved, manipulated, created, or stored by processor(s) 612. The data 618 can include geographic data to be served as part of the geographic information system, such as polygon meshes, textures, vector data, and other geographic data. The geographic data can be stored in a hierarchical tree data structure, such as quadtree or octree data structure, that spatially partitions the geographic data according to geospatial coordinates. The data 618 can be stored in one or more databases. The one or more databases can be connected to the server 610 by a high bandwidth LAN or WAN, or can also be connected to server 610 through network 640. The one or more databases can be split up so that they are located in multiple locales.

The server 610 can exchange data with one or more client devices 630 over the network 640. Although two client devices 630 are illustrated in FIG. 8, any number of client devices 630 can be connected to the server 610 over the network 640. The client devices 630 can be any suitable type of computing device, such as a general purpose computer, special purpose computer, laptop, desktop, mobile device, smartphone, tablet, wearable computing device, or other suitable computing device.

Similar to the computing device 610, a client device 630 can include a processor(s) 632 and a memory 634. The processor(s) 632 can include one or more central processing units, graphics processing units dedicated to efficiently rendering images, and/or other suitable processor(s). The memory 634 can store information accessible by processor(s) 632, including instructions 636 that can be executed by processor(s) 632. For instance, the memory 634 can store instructions 636 for implementing an application that provides a user interface (e.g. a browser) for interacting with the geographic information system. The memory 634 can also store instructions 636 for implementing a rendering module. The rendering module can be configured to render a textured polygon mesh to provide a graphical representation of a three-dimensional model of a geographic area.

The memory 634 can also store data 638, such as polygon meshes, textures, vector data, and other geographic data received by the client device 630 from the server 610 over the network. The geographic data can be stored in a hierarchical tree data structure that spatially partitions the geographic data according to geospatial coordinates associated with the data.

The client device 630 can include various input/output devices for providing and receiving information from a user, such as a touch screen, touch pad, data entry keys, speakers, and/or a microphone suitable for voice recognition. For instance, the client device 630 can have a display 635 for rendering the graphical representation of the three-dimensional model.

The client device 630 can also include a network interface used to communicate with one or more remote computing devices (e.g. server 610) over the network 640. The network interface can include any suitable components for interfacing with one more networks, including for example, transmitters, receivers, ports, controllers, antennas, or other suitable components.

The network 640 can be any type of communications network, such as a local area network (e.g. intranet), wide area network (e.g. Internet), or some combination thereof. The network 640 can also include a direct connection between a client device 630 and the server 610. In general, communication between the server 610 and a client device 630 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of performing a two-dimensional image processing operation on a texture atlas mapped to a surface of a three-dimensional model, the method comprising:
accessing, with a computing device, the texture atlas, the texture atlas comprising a first pixel mapped to a first point on a surface of the three-dimensional model;
defining, with the computing device, a manifold neighborhood for the first pixel, the manifold neighborhood comprising a set of second pixels associated with the texture atlas, each second pixel in the set of second pixels respectively corresponding to a second point on the surface of the three-dimensional model located within a threshold distance of the first point on the surface of the three-dimensional model in a three-dimensional space defined by the three-dimensional model; and
performing, with the computing device, a two-dimensional image processing operation on the texture atlas in a two-dimensional texture atlas space based at least in part on the manifold neighborhood defined for the first pixel;
wherein defining the manifold neighborhood for the first pixel comprises identifying a set of second points on the surface of the three-dimensional model located within a threshold distance of the first point on the surface of the three-dimensional model in the three-dimensional space, identifying the set of second pixels in the texture atlas in the two-dimensional texture atlas space corresponding to the set of second points on the surface of the three-dimensional model in the three-dimensional space, and defining the manifold neighborhood as the set of second pixels in the texture atlas.

2. The computer-implemented method of claim 1, wherein the texture atlas comprises a plurality of charts.

3. The computer-implemented method of claim 2, wherein the manifold neighborhood extends across the plurality of charts.

4. (canceled)

5. The computer-implemented method of claim 1, wherein performing a two-dimensional image processing operation on the texture atlas comprises:
constructing an output texture atlas, the output texture atlas comprising an output pixel corresponding to the first pixel in the texture atlas;
determining a pixel value for the output pixel based at least in part on the set of second pixels in the manifold neighborhood; and
setting the pixel value to the output pixel in the output texture atlas.

6. The computer-implemented method of claim 1, wherein performing a two-dimensional image processing operation on the texture atlas comprises processing the texture atlas to generate an image pyramid, the image pyramid having a base level associated with the texture atlas and a first level having a lower resolution than the base level.

7. The computer-implemented method of claim 6, wherein an upsampling operation or a downsampling operation is performed to generate the image pyramid.

8. The computer-implemented method of claim 6, wherein processing the texture atlas to generate an image pyramid comprises:
constructing the first level of the image pyramid, the first level comprising a third pixel corresponding to the first pixel in the texture atlas;
determining a pixel value for the third pixel based at least in part on the set of second pixels in the manifold neighborhood for the first pixel; and
setting the pixel value to the third pixel in the first level of the image pyramid.

9. The computer-implemented method of claim 8, wherein determining a pixel value for the third pixel comprises determining a weighting factor for each of the set of second pixels, the weighting factor for each second pixel determined based at least in part on a distance between the second point on the surface of the three-dimensional model corresponding to the second pixel and the first point on the surface of the three-dimensional model corresponding to the first pixel.

10. The computer-implemented method of claim 6, wherein the two-dimensional image processing operation is a multi-band blending operation.

11. The computer-implemented method of claim 1, wherein a manifold neighborhood is defined for each of a plurality of pixels in the texture atlas.

12. The computer-implemented method of claim 1, wherein the image processing operation is a blending operation, a compression operation, an enhancement operation, an editing operation, a synthesis operation, or a fusion operation.

13. The computer-implemented method of claim 1, wherein the three-dimensional model is a three-dimensional model of a geographic area.

14. A computing system for performing a two-dimensional image processing operation on a texture atlas mapped to a surface of a three-dimensional model, the system comprising:
one or more processors; and
one or more computer-readable media;
a texture module implemented by the one or more processors, the texture module configured to access the texture atlas comprising a first pixel mapped to a first point on a surface of the three-dimensional model, the texture module further configured to define a manifold neighborhood for the first pixel, the manifold neighborhood comprising a set of second pixels;
an image processing module implemented by the one or more processors, the image processing module configured to perform a two-dimensional image processing operation on the texture atlas based at least in part on the manifold neighborhood defined for the first pixel;
wherein each second pixel in the set of second pixels respectively corresponds to a point in the three-dimensional model located within a threshold distance of the first point on the surface of the three-dimensional model in a three-dimensional space defined by the three-dimensional model; and
wherein the texture module is configured to define the manifold neighborhood for the first pixel by identifying a set of second points on the surface of the three-dimensional model located within a threshold distance of the first point on the surface of the three-dimensional model in the three-dimensional space, identifying the set of second pixels in the texture atlas in the two-dimensional texture atlas space corresponding to the set of second points on the surface of the three-dimensional model in the three-dimensional space, and defining the manifold neighborhood as the set of second pixels in the texture atlas.

15. The computing system of claim 14, wherein the image processing module is configured to construct an output texture atlas comprising an output pixel corresponding to the first pixel in the texture atlas, the image processing module further configured to determine a pixel value for the output pixel based at least in part on the set of second pixels in the manifold neighborhood, the image processing module further configured to set the pixel value to the output pixel in the output texture atlas.

16. The computing system of claim 14, wherein the image processing module is configured to process the texture atlas to generate an image pyramid, the image pyramid having a base level associated with the texture atlas and a first level having a lower resolution than the base level.

17. The computing system of claim 16, wherein the image processing module is configured to construct the first level of the image pyramid, the first level comprising a third pixel corresponding to the first pixel in the texture atlas, the image processing module further configured to determine a pixel value for the third pixel based at least in part on the set of second pixels in the manifold neighborhood for the first pixel, the image processing module further configured to set the pixel value to the third pixel in the first level of the image pyramid.

18. A computer program product comprising a tangible non-transitory computer-readable medium storing computer-readable instructions that when executed by one or more processing devices cause the one or more processing devices to perform operations, comprising:
accessing a texture atlas comprising a first pixel mapped to a first point on a surface of a three-dimensional model;
defining a manifold neighborhood for the first pixel, the manifold neighborhood comprising a set of second pixels, each second pixel in the set of second pixels respectively corresponding to a second point in the three-dimensional model located within a threshold distance of the first point on the surface of the three-dimensional model in a three-dimensional space defined by the three-dimensional model; and
performing a two-dimensional image processing operation on the texture atlas in a two-dimensional texture atlas space based at least in part on the manifold neighborhood defined for the first pixel;
wherein defining the manifold neighborhood for the first pixel comprises identifying a set of second points on the surface of the three-dimensional model located within a threshold distance of the first point on the surface of the three-dimensional model in the three-dimensional space, identifying the set of second pixels in the texture atlas in the two-dimensional texture atlas space corresponding to the set of second points on the surface of the three-dimensional model in the three-dimensional space, and defining the manifold neighborhood as the set of second pixels in the texture atlas.

19. The computer program product of claim 18, wherein the operation of performing a two-dimensional image processing operation comprises:
constructing an output texture atlas, the output texture atlas comprising an output pixel corresponding to the first pixel in the texture atlas;
determining a pixel value for the output pixel based at least in part on the set of second pixels in the manifold neighborhood; and
setting the pixel value to the output pixel in the output texture atlas.

20. The computer-program product of claim 18, wherein the two-dimensional image processing operation is a blending operation, a compression operation, an enhancement operation, an editing operation, a synthesis operation, or a fusion operation.
